(19) United States
(12) Patent Application Publication
(10) Pub. No.: US 2024/0112147 A1
(43) Pub. Date: Apr. 4, 2024

(54) SYSTEMS AND METHODS TO PROVIDE SERVICES TO A DISABLED VEHICLE

(71) Applicant: Ford Global Technologies, LLC, Dearborn, MI (US)

(72) Inventors: Keith Weston, Canton, MI (US); Brendan Diamond, Grosse Pointe, MI (US); Jordan Barrett, Milford, MI (US); Michael Alan Mcnees, Flat Rock, MI (US); Andrew Denis Lewandowski, Sterling Heights, MI (US)

(73) Assignee: Ford Global Technologies, LLC, Dearborn, MI (US)

(21) Appl. No.: 17/937,402

(22) Filed: Sep. 30, 2022

(51) Int. Cl. G06Q 10/00; G06Q 50/10

(52) U.S. Cl. CPC G06Q 10/20; G06Q 50/10

(57) ABSTRACT

This disclosure is generally directed to systems and methods related to providing assistance services to a disabled vehicle. In an example embodiment, a method executed by a first processor in a vehicle may involve detecting an event that places the vehicle in a disabled condition; transmitting information associated with the event to a second processor; and detecting an arrival of a assistance vehicle that is dispatched by the second processor based on an automated evaluation of the information associated with the event. The second processor, which can be, for example, a part of a server computer, may evaluate the information in order to identify an assistance vehicle having equipment for providing the assistance service. In an example scenario, the disabled vehicle and/or the assistance vehicle can be an autonomous vehicle.

### BACKGROUND

A vehicle may be rendered immobile due to a variety of reasons such as when it is involved in an accident or becomes disabled. At these times, a driver of the vehicle has to perform several actions that can include identifying a towing service or a repair service that can render assistance. Such actions can be time consuming. It is therefore desirable to provide a solution that addresses this issue.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example vehicle that includes an assistance services computer in accordance with an embodiment of the disclosure.

FIG. 2 illustrates an example scenario where the assistance services computer performs certain operations in accordance with the disclosure.

FIG. 3 illustrates a flowchart of a method to provide a vehicle assistance service in accordance with an embodiment of the disclosure.

FIG. 4 shows some example components that may be provided in a vehicle in accordance with an embodiment of the disclosure.

FIG. 5 shows some example components that may be included in a services provider computer in accordance with an embodiment of the disclosure.

### DETAILED DESCRIPTION

### Overview

In terms of a general overview, certain embodiments described in this disclosure are directed to systems and methods related to providing assistance services to a disabled vehicle. In an example embodiment, a method executed by a first processor in a vehicle may involve detecting an event that results in the vehicle being placed in a disabled condition. The method can further involve transmitting information associated with the event to a second processor, and detecting an arrival of an assistance vehicle that is dispatched by the second processor based on an automated evaluation of the information associated with the event. The second processor, which can be, for example, a part of a server computer, may evaluate the information in order to identify an assistance vehicle having equipment for providing the assistance service. In an example scenario, the disabled vehicle and/or the assistance vehicle can be an autonomous vehicle.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words, terms, and phrases that are used in this disclosure must be interpreted as referring to various objects and actions that are generally understood in various forms and equivalencies by persons of ordinary skill in the art. For example, the word “software” as used herein encompasses any of various forms of computer code and may be provided in various forms such as in the form of a software package, a firmware package, retail software, or Original Equipment Manufacturer (OEM) software. The word “sensor” as used herein includes any of various forms of sensing devices, detection devices, and image capture devices. The word “cooperate,” as used herein with reference to two or more devices, refers to transfer of information between the devices. The word “information,” as used herein with reference to a device, refers to any of various forms of data produced by the device such as, for example, digital data. It must be understood that words such as “implementation,” “configuration,” “application,” “scenario,” “situation,” “case,” and “situation” as used herein represent abbreviated versions of the phrase “In an example (“implementation,” “configuration,” “application,” “scenario,” “situation,” “case,” “approach,” and “situation”) in accordance with the disclosure.” It must also be understood that the word “example” as used herein is intended to be non-exclusionary and non-limiting in nature.

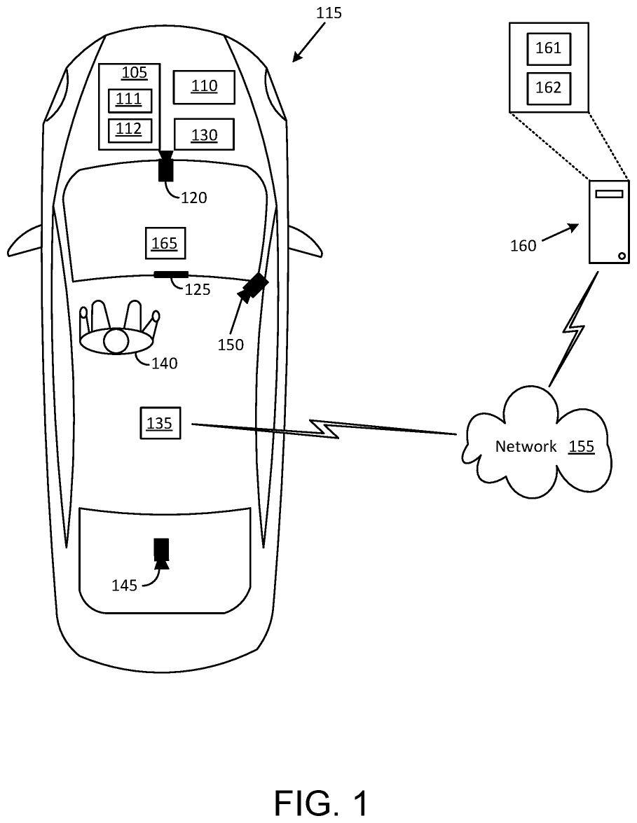

FIG. 1 illustrates an example vehicle 115 that is configured to execute various operations in accordance with the disclosure. The example vehicle 115 shown in FIG. 1 is a driver-operated vehicle that is operated by a driver 140. However, in other scenarios, the vehicle 115 can be any of various types of vehicles such as, for example, a gasoline powered vehicle, an electric vehicle, a hybrid electric vehicle, a car, a sports utility vehicle (SUV), a truck, a van, a semi-trailer truck, a bus, a driver-operated vehicle, or an autonomous vehicle.

The vehicle 115 can include various components such as, for example, a vehicle computer 110, an assistance services computer 105, an infotainment system 125, a sensor system 130, a global positioning satellite (GPS) system 165, and a communication system 135. The vehicle computer 110 may perform various functions such as, for example, controlling engine operations (fuel injection, speed control, emissions control, braking, etc.), managing climate controls (air conditioning, heating etc.), detecting airbag activations, and issuing alerts (check engine light, bulb issue, low tire pressure, vehicle in blind spot, etc.). In some cases, the vehicle computer 110 may include more than one computer such as, for example, a first computer that controls engine operations and a second computer that operates the infotainment system 125.

The assistance services computer 105 can include a processor 111 and a memory 112 in which is stored computer-executable instructions that are executed by the processor 111 to enable the assistance services computer 105 to perform various operations in accordance with the disclosure. In an example configuration, the assistance services computer 105 can include the assistance services computer 105 configured as a standalone computer that is communicatively coupled to the vehicle computer 110 and other devices in the vehicle 115. In this configuration, the assistance services computer 105 can obtain from the vehicle computer 110 and one or more of the other devices, information pertaining to an event in accordance with disclosure (a crash, vehicle breakdown, etc.). In another example implementation, the assistance services computer 105 can be a part of the vehicle computer 110 and share some components with the vehicle computer 110, such as, for example a processor and a memory.

The sensor system 130, which is coupled to the assistance services computer 105, can include various types of devices such as, for example, an accelerometer, a video camera, a digital camera, an infrared camera, an object detector, a distance sensor, a proximity sensor, an audio sensor, a light detection and ranging (LIDAR) device, a radar device, and/or a sonar device. In an example embodiment, a camera 120, a camera 150, a camera 145, an accelerometer of the sensor system 130, and other sensors and detectors are coupled to the assistance services computer 105.

The camera 120 can be any of various types of image capture devices mounted at any of various locations on the vehicle 115 such as, for example, on a front bumper, on a hood, above a registration plate, or in the engine compartment. The camera 120 is arranged to capture images of objects located ahead of the vehicle 115. The images may be still pictures, video clips, or video streams, for example. The camera 145, which can be similar to camera 120, may be mounted on a rear window, rear bumper, or trunk of the vehicle 115 and arranged to capture images of objects located behind the vehicle 115. The camera 150, which can be a video camera or a digital camera, for example, similar to camera 120, may be mounted in the cabin area of the vehicle 115 such as, for example, on a dashboard, a side pillar, a rear-view mirror, or a ceiling of the vehicle 115. The camera 150 is arranged to capture images of the occupants of the vehicle 115. The images, which can be digital images or video clips in various implementations, may be provided to the assistance services computer 105 for evaluation for various purposes including, for example, to determine a physical status of an occupant (particularly, the driver 140) after an event has occurred (a crash or a collision, for example).

In an example scenario, the accelerometer, which may also be referred to as a “g sensor,” produces a sensor signal upon detecting an abrupt change in motion of the vehicle 115, such as, for example, a sudden deceleration or stoppage of the vehicle 115. The sensor signal is conveyed to the assistance services computer 105 and the vehicle computer 110, each of which evaluates the sensor signal and determines that the vehicle 115 is involved in a traffic accident. In one case, the traffic accident can be a collision between the vehicle 115 and another vehicle. The collision can be, for example, a rear-ending of the vehicle 115 by another vehicle, or vice-versa.

In an example situation, where the vehicle 115 rear-ends the other vehicle, the camera 120, which can be a video camera executing a real-time video recording, captures and stores video footage prior to, at the time of, and after, the moment of impact between the two vehicles. The video footage may be stored in the memory 112 for access by the processor 111 and for use as information pertaining to the collision in accordance with disclosure.

In another example situation, where the vehicle 115 is rear-ended by the other vehicle, the camera 145, which can be a video camera executing a real-time video recording, captures and stores video footage prior to, at the time of, and after, the moment of impact between the two vehicles. The video footage may be stored in the memory 112 for access by the processor 111 and for use as information pertaining to the collision in accordance with disclosure.

In yet another example situation, where the vehicle 115 has stopped unexpectedly due to any of various reasons the camera 150, which can be a video camera executing a real-time video recording, captures and stores video footage of one or more occupants of the vehicle 115, prior to, at the time of, and after, the moment of stoppage. The video footage may be stored in the memory 112 for access by the processor 111 and for use as information pertaining to the collision, such as a physical status and/or a mental condition of the occupants, in accordance with disclosure.

The infotainment system 125 can be an integrated unit that includes various components such as a radio, a CD player, and a video player. In an example implementation, the infotainment system 125 has a display that includes a graphical user interface (GUI) for use by the driver 140 of the vehicle 115. The GUI may be used for various purposes including, for example, to input various types of information after an occurrence of an event. In an example scenario, the GUI may be used by the driver 140 to provide to the assistance services computer 105, information pertaining to a physical status and/or a mental condition of the driver 140 and/or other occupants of the vehicle 115. The GUI may also be used by an occupant of the vehicle 115 to request various forms of assistance after an event has occurred such as, for example, a request for medical assistance, a request for medical supplies, and a request for water and/or food.

The GPS system 165 may be communicatively coupled to the infotainment system 125 (for providing navigation information) and may also be communicatively coupled to the assistance services computer 105 (for providing location information after the occurrence of an event).

The communication system 135 can include wired and/or wireless communication devices mounted in or on the vehicle 115 in a manner that support various types of communications such as, for example, communications between the assistance services computer 105 and the vehicle computer 110. The communication system 135 may utilize one or more of various wired and/or wireless technologies for this purpose, such as, for example, Bluetooth®, Ultra-Wideband (UWB), Wi-Fi, Zigbee®, Li-Fi (light-based communication), audible communication, ultrasonic communication, and/or near-field-communications (NFC).

The assistance services computer 105 and the vehicle computer 110 can also utilize the communication system 135 to communicate with devices that are located outside the vehicle 115, such as, for example, a computer 160. The computer 160 can include a processor 161 and a memory 162 in which is stored computer-executable instructions that are executed by the processor 161 to enable the assistance services computer 105 to perform various operations in accordance with the disclosure.

In an example scenario, the computer 160 is a server computer. In another example scenario, the computer 160 is a cloud computer. In yet another example scenario, the computer 160 is a computer that is dedicated for purposes of providing assistance services in accordance with disclosure. The computer 160 is referred to below in various instances as a services provider computer 160. Communications between the assistance services computer 105 in the vehicle 115 and the services provider computer 160 may be carried out via a network 155. The network 155 may include any one network, or a combination of networks, such as, for example, a local area network (LAN), a wide area network (WAN), a telephone network, a cellular network, a cable network, a wireless network, and/or private/public networks such as the Internet.

The network 155 may support one or more types of communication technologies such as, for example, Transmission Control Protocol/Internet Protocol (TCP/IP), Cellular, Bluetooth®, Ultra-Wideband, near-field communication (NFC), Wi-Fi, Wi-Fi direct, Li-Fi, vehicle-to-vehicle (V2V) communications, vehicle-to-infrastructure (V2I) communications, and vehicle-to-everything (V2X) communications.

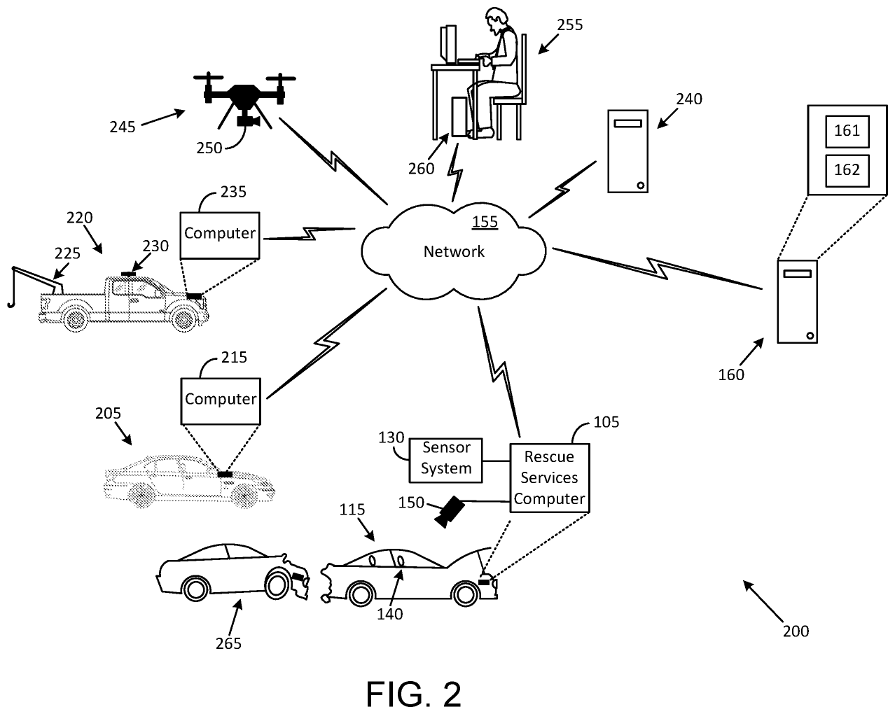

FIG. 2 illustrates an example scenario where the vehicle 115 is in a disabled condition and the assistance services computer 105 performs certain operations in accordance with the disclosure. The various objects illustrated in FIG. 2 are example objects associated with an assistance services system 200 in accordance with an embodiment of the disclosure.

In the illustrated example scenario, the vehicle 115 may be in the disabled condition as a result of a collision with another vehicle 265. The collision is one example of an event in accordance with disclosure. In this case, the vehicle 115 may be in a partly damaged condition and may be drivable over a short distance (such as, for example, to a shoulder of a road) or may be rendered completely undriveable and immobile at the spot of the collision (middle of a road, for example). In another example scenario, the vehicle 115 is in the disabled condition, the vehicle 115 may be partially drivable or completely undriveable and immobile.

An accelerometer of the sensor system 130 in the vehicle 115 may detect the occurrence of the event and generate a sensor signal that is conveyed to the assistance services computer 105. The assistance services computer 105 evaluates the sensor signal and determines that the vehicle 115 has been placed in a disabled condition as a result of the event. The assistance services computer 105 may then communicate with the GPS system 165 to obtain location information of the vehicle 115. The location information of the vehicle 115 can be used by the assistance services computer 105 to identify a site at which the vehicle 115 is in the disabled condition. In another case, the occurrence of the event may be detected by other types of sensors and/or may be reported to the assistance services computer 105 by the driver 140 of the vehicle 115 (via the GUI of the infotainment system 125, for example).

The assistance services computer 105 may also obtain from various sources, other types of information associated with the event such as, for example, a cause of the event (crash, collision, a time of occurrence of the event, a cause for the occurrence of the event, a health status of an occupant of the vehicle 115, conditions at the site at which the event has occurred (traffic conditions, weather conditions, road conditions, neighboring structures, individuals present near the vehicle 115, etc.), and/or a condition of the vehicle 115.

Such information may be obtained in the form of sensor signals provided by various types of sensors that are included in the sensor system 130 and/or in the form of images captured by cameras such as, for example, the camera 120, the camera 145, and/or the camera 150.

The assistance services computer 105 may convey information (such as the ones described above) to the services provider computer 160 via the network 155. In an example scenario in accordance with the disclosure, the assistance services computer 105 automatically conveys the information to the services provider computer 160 without human involvement. The automatic operation of the assistance services computer 105 can be particularly useful when the driver 140 is in no condition to take action and/or when timely assistance is critical.

In an example scenario, the assistance services computer 105 may evaluate the information obtained from the sensors/cameras and determine a nature of service that is desired (towing, jump start, medical aid, etc.). Based on the evaluation and determination, the assistance services computer 105 may request a specific type of service in the request for assistance (a request for assistance in the form of a tow truck, for example). In some cases, the assistance services computer 105 may include in the request for assistance information pertaining to the vehicle 115 such as, for example, a description of the vehicle 115, a vehicle identification number (VIN), vehicle registration information, and/or vehicle ownership information.

The assistance services computer 105 may further determine one or more actions that can be performed automatically by the assistance services computer 105 without involvement of the driver 140, and other actions that may be performed by the driver 140. Actions that may be performed by the driver 140 can be based on the assistance service computer 105 assessing a physical and/or mental condition of the driver 140 due to the traffic accident. The assessment may be carried out by the assistance services computer 105 in cooperation with sensing devices provided in the vehicle 115 and/or worn by the driver 140. The sensing devices can include, for example, a heart rate monitor, a blood pressure monitor, and/or a smartwatch. In an example scenario, the assessment can be carried out by evaluating one or more images captured by the camera 150 located in the cabin area of the vehicle 115.

In one example situation, the assistance services computer 105 may determine that the driver 140 is relatively composed and may be capable of performing some operations such as, for example, operating the vehicle 115, getting out of the vehicle 115, taking part in an assistance operation (attaching a tow cable, jump starting the vehicle 115, maneuvering the vehicle 115, etc.). In another example situation, the assistance services computer 105 may determine that the driver 140 is shaken up to a point where the driver 140 is incapable of performing such operations. Information pertaining to the driver 140 may be conveyed by the assistance services computer 105 to the services provider computer 160.

The services provider computer 160 receives the information provided by the assistance services computer 105 and evaluates the information in order to identify a vehicle that is suitable for providing an assistance service to the vehicle 115. In one example scenario, the services provider computer 160 may access a database contained in the services provider computer 160 to obtain information about various vehicles that can operate as assistance vehicles. In another example scenario, the services provider computer 160 may communicate with a computer 240 to obtain information about various vehicles that can operate as assistance vehicles. The computer 240 can, for example, be a cloud computer including a database in which information about various vehicles is stored.

In an example embodiment, the various assistance vehicles may be either driver-operated vehicles or autonomous vehicles. The drivers of the driver-operated vehicles may be either volunteers who provide assistance services on a voluntary basis or drivers who provide assistance services based on various types of incentives. In one case, the incentives can be offered in the form of cash, cryptocurrency, or rewards. In another case, a driver of an assistance vehicle may be selected on the basis of an auction process where multiple individuals place a bid for fulfilment of an assistance service. In some cases, crowd-based solutions may be applied for various purpose such as, for example, to obtain assistance service drivers, to obtain information about the collision that caused the vehicle 115 to be placed in the disabled condition, and/or to obtain real-time information about the vehicle 115 and surroundings. Such information may be utilized by the services provider computer 160 to provide various types of assistance services in accordance with the disclosure.

In a first example scenario, the information provided by the assistance services computer 105 to the services provider computer 160 may indicate a need for food and/or water. The services provider computer 160 may consequently seek to identify a vehicle that is suitable for transporting food and/or water to the site where the vehicle 115 is located. A sedan may be found suitable for this purpose due to various reasons such as, for example, characteristics of the vehicle 205 (driver-operated, autonomous, size, speed, etc.), a current location of the vehicle 205 with respect to the vehicle 115, and a suitable storage area for transporting food and water (trunk, back seat, etc.). The services provider computer 160 may accordingly communicate with a computer 215 provided in the vehicle 205 to direct the vehicle 205 to transport the items to the vehicle 115. The services provider computer 160 may also provide directions to the computer 215 (if the vehicle 205 is an autonomous vehicle) or to a driver of the vehicle 205 (if the vehicle 205 is a driver-operated vehicle). Communications with the driver of the vehicle 205 may be carried out via the computer 215 and an infotainment system (not shown) in the vehicle 205.

In a second example scenario, the information provided by the assistance services computer 105 to the services provider computer 160 may indicate a need for towing the vehicle 115. The services provider computer 160 may consequently seek to identify a vehicle that is suitable for providing a towing service. In this scenario, the vehicle 205 may be unsuitable for providing the assistance service and the services provider computer 160 may select a tow truck 220 that includes towing equipment 225. The tow truck 220 can include a computer 235 and can be either a driver-operated vehicle or an autonomous vehicle. If the tow truck 220 is an autonomous vehicle, the tow truck 220 may include some types of equipment such as, for example, a camera 230 that can be used to control various actions performed by the tow truck 220. In an example situation, the actions performed by the tow truck 220 can be controlled from a remote location by an operator 255 of a computer 260. The computer 260 may include a joy stick, mouse, keypad etc. that can be used for executing the control operations.

Upon selecting the tow truck 220, the services provider computer 160 may communicate with the computer 235 provided in the tow truck 220 to direct the tow truck 220 to travel to the site where the vehicle 115 is located. The services provider computer 160 may also provide directions to the computer 235 (if the tow truck 220 is an autonomous vehicle) or to a driver of the tow truck 220 (if the tow truck 220 is a driver-operated vehicle). Communications with the driver of the tow truck 220 may be carried out via the computer 235 and an infotainment system (not shown) in the tow truck 220.

In an example situation, the computer 260 and/or the services provider computer 160 may provide instructions to the driver 140 of the vehicle 115 for participating in the assistance operation performed by the tow truck 220. For example, the driver 140 may be instructed to retrieve a tow cable from the tow truck 220 and to use the tow cable to couple the tow truck 220 to the vehicle 115. In another example situation, the tow truck 220 may include one or more robotic devices such as, for example, a robotic arm, that can be operated by the computer 260 for performing various actions with, or without, help from the driver 140 such as, for example, to attach a tow cable to the vehicle 115.

In a third example scenario, the information provided by the assistance services computer 105 to the services provider computer 160 may not provide a physical status of the driver 140 of the vehicle 115 and/or information about the accident such as, for example, an extent of damage to the vehicle 115 and/or an environment around the vehicle 115 (traffic density, ice/snow presence, whether stuck in mud, etc.). In such a scenario, the services provider computer 160 may communicate with an unmanned aerial vehicle (UAV) 245 and dispatch the UAV 245 to the site where the vehicle 115 is located.

The UAV 245 may include some types of equipment such as, for example, a camera 250, that can be used to capture images of the vehicle 115, objects around the vehicle 115, and objects located inside the vehicle 115 (capturing images through the windows of the vehicle 115). In an example implementation, the actions may be controlled from a remote location by the operator 255 by use of the computer 260. Images captured by the UAV 245 may be conveyed to the services provider computer 160 either directly from the UAV 245 or via the computer 260.

In a fourth example scenario, the information provided by the assistance services computer 105 to the services provider computer 160 may indicate a need for more than one vehicle to provide assistance services. In this scenario, the services provider computer 160 may dispatch multiple vehicles such as, for example, the vehicle 205 and the tow truck 220. In some cases, the UAV 245 may be dispatched as well. The UAV 245 may not only capture images but, in some situations, may also provide other forms of assistance such as, for example, transporting items to the site of the vehicle 115, guiding the tow truck 220 and/or the vehicle 205 to the site of the vehicle 115, providing maneuvering directions to the tow truck 220 and/or the vehicle 205 for carrying out assistance operations at the site of the vehicle 115, etc.

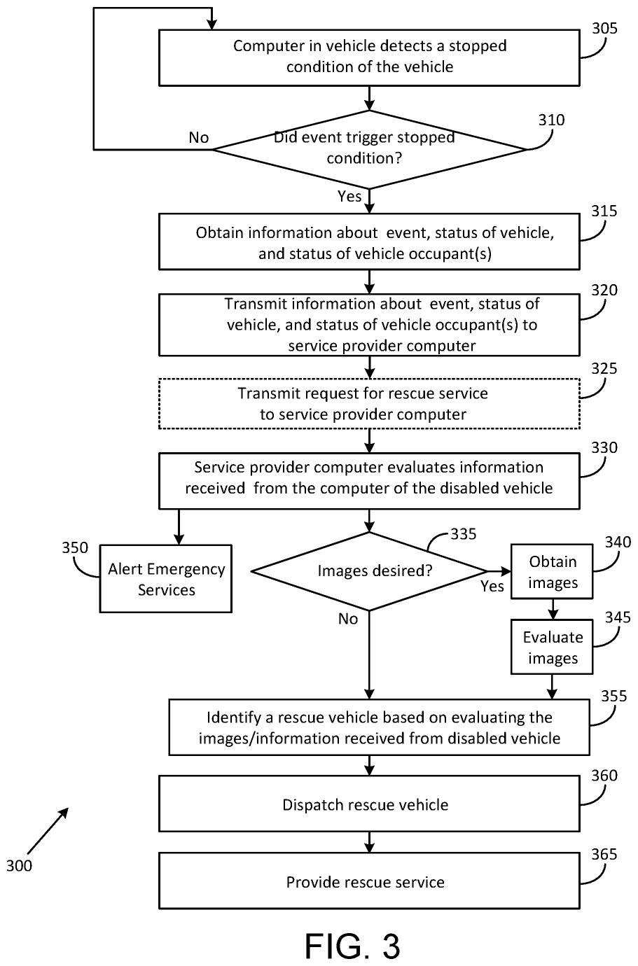

FIG. 3 illustrates a flowchart 300 of a method to provide a vehicle assistance service in accordance with an embodiment of the disclosure. The flowchart 300 illustrates a sequence of operations that can be implemented in hardware, software, or a combination thereof. In the context of software, the operations represent computer-executable instructions stored on one or more non-transitory computer-readable media such as the memory 112 of the assistance services computer 105, that, when executed by one or more processors such as the processor 111 of the assistance services computer 105, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. The vehicle 115 and the various aspects described above with reference to FIG. 2 are referred to below in the form of examples and it must be understood that the description of the flowchart 300 is equally applicable to various other vehicles and various other scenarios.

At block 305, the assistance services computer 105 may detect that the vehicle 115 is in a stopped condition. The stopped condition can be a part of a routine event (stopped at a traffic light, for example) or can be due to the occurrence of an event such as a collision.

At block 310, a determination is made by the assistance services computer 105 whether the stopped condition is a result of an event. The occurrence of an event may be detected in various ways. In one example scenario, the assistance services computer 105 may detect the event based on evaluating information received from various detection devices such as, for example, a signal received from an accelerometer, an image captured by a camera, and/or a signal received from the vehicle computer 110.

If the stopped condition is not as a result of an event, the actions indicated by block 305 and block 310 are executed recursively. If the stopped condition is due to an event, at block 315, the assistance services computer 105 can obtain information about the event such as, for example, a status of the vehicle 115 and a status of one or more occupants present in the vehicle 115. In an example scenario, the assistance services computer 105 may evaluate the information and make a determination to provide advice to the driver 140 for performing some actions such as, for example, moving the vehicle 115, contacting emergency services, and/or gathering information for filing an insurance claim.

In another example scenario, at block 320, the assistance services computer 105 may not evaluate the information obtained from the various sensors and act upon the information in the manner described above (providing advice to the driver 140) but may instead forward the collected information to the services provider computer 160. In this scenario, the services provider computer 160 can evaluate the information and carry out actions such as providing advice to the driver 140 (moving the vehicle, collecting insurance information, etc.)

The next operation indicated in block 325 of the flowchart 300, may be optional. In one example scenario, the assistance services computer 105 may not explicitly convey a request for services to the services provider computer 160 because the services provider computer 160 can evaluate the information and make a determination as to what type of help, if any, is warranted. However, in another example scenario, the assistance services computer 105 may convey a request for services to the services provider computer 160 such as, for example, in order to specify a specific type of service (medical, towing, food, first aid kit, medicine, etc.).

At block 330, the services provider computer 160 evaluates the information received from the assistance services computer 105 in order to identify a vehicle that is suitable for providing an assistance service to the vehicle 115.

In at least some cases, the information provided by the assistance services computer 105 to the services provider computer 160 may be inadequate in some ways. For example, the information may not provide a physical status of the driver 140 of the vehicle 115 and/or extent of damage to the vehicle 115 and/or information about an environment in the vicinity of the vehicle 115 (traffic density, ice/snow presence, whether stuck in mud, etc.).

Consequently, at block 335 a determination is made whether images are desired. The images may be required to complement or to supplement information already provided by the assistance services computer 105 (including images captured by one or more cameras in the vehicle 115).

If images are desired, at block 340, the services provider computer 160 arranges for images to be obtained. In an example scenario, the services provider computer 160 may communicate with the assistance services computer 105 to obtain additional images. In another example scenario, the services provider computer 160 may do so by dispatching the UAV 245 to the site where the vehicle 115 is located.

At block 345, one or more images obtained from the assistance service computer 105 and/or from the UAV 245, for example, are evaluated by the services provider computer 160.

If at block 335 the determination indicates that no images are desired, at block 355, an assistance vehicle is identified in the manner described above. Identification of the assistance vehicle may also be carried out based on the evaluation operation indicated by block 345.

At block 360, the assistance vehicle is dispatched by the services provider computer 160 to the site where the disabled vehicle is located.

At block 365, an assistance service is provided (towing the disabled vehicle, providing food/medicine, etc.). The assistance service may be performed by the assistance vehicle, either independently or in cooperation with an occupant of the disabled vehicle. Some example operations are described above.

Referring back to actions performed subsequent to block 330, at block 350, the services provider computer 160 may alert emergency services (ambulance, police, etc.) about the disabled vehicle. Pertinent information about the occupants of the disabled vehicle may also be conveyed to the emergency personnel.

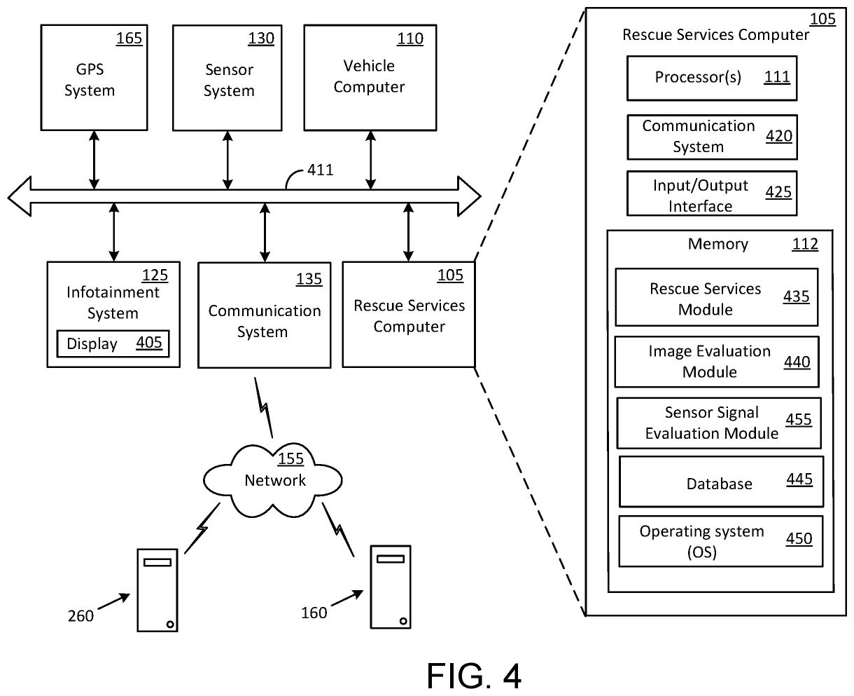

FIG. 4 shows some example components that may be included in the vehicle 115 in accordance with an embodiment of the disclosure. The example components may include the communication system 135, the vehicle computer 110, the infotainment system 125, the sensor system 130, the GPS system 165, and the assistance services computer 105.

The various components are communicatively coupled to each other via one or more buses such as, for example, a bus 411. The bus 411 may be implemented using various wired and/or wireless technologies. For example, the bus 411 can be a vehicle bus that uses a controller area network (CAN) bus protocol, a Media Oriented Systems Transport (MOST) bus protocol, and/or a CAN flexible data (CAN-FD) bus protocol. Some or all portions of the bus 411 may also be implemented using wireless technologies such as Bluetooth®, Bluetooth®, Ultra-Wideband, Wi-Fi, Zigbee®, or near-field-communications (NFC). For example, the bus 411 may include a Bluetooth® communication link that allows the assistance services computer 105 and the sensor system 130 to wirelessly communicate with each other and/or the assistance services computer 105 to communicate with the vehicle computer 110.

The communication system 135 can include wired and/or wireless communication devices mounted in or on the vehicle 115 in a manner that support various types of communications such as, for example, communications between the assistance services computer 105 and the vehicle computer 110. The communication system 135 may also allow the assistance services computer 105 to communicate with devices located outside the vehicle 115, such as, for example, the services provider computer 160 and/or the computer 260.

In an example implementation, the communication system 135 can include a single wireless communication unit that is coupled to a set of wireless communication nodes. In some cases, the wireless communication nodes can include a Bluetooth® low energy module (BLEM) and/or a Bluetooth® low energy antenna module (BLEAM).

The infotainment system 125 can include a display 405 having a GUI for carrying out various operations. The GUI may be used to allow the driver 140 to input information such as, for example, a response to a query from the assistance services computer 105 regarding a medical condition of the driver 140 after a traffic accident.

The sensor system 130 can include various types of devices such as, for example, an accelerometer, a video camera, a digital camera, an infrared camera, an object detector, a distance sensor, a proximity sensor, an audio sensor, a light detection and ranging (LIDAR) device, a radar device, and/or a sonar device.

The GPS system 165 can include a GPS device that communicates with a GPS satellite for obtaining location information, including, for example, a location of the vehicle 115. The location information of the vehicle 115 may be utilized by various entities, such as, for example, the services provider computer 160, the computer 260, and the UAV 245 to locate the vehicle 115 when the vehicle 115 is in a disabled condition.

The assistance services computer 105 may include a processor 111, a communication system 420, an input/output interface 425, and a memory 112. The communication system 420 can include various types of transceivers that allow the assistance services computer 105 to communicate with the vehicle computer 110 (via the bus 411) and other computers (wirelessly via the network 155).

The input/output interface 425 can be used to allow various types of signals and information to pass into, or out of, the assistance services computer 105. For example, the input/output interface 425 may be used by the assistance services computer 105 to receive a sensor signal from an accelerometer upon the occurrence of a traffic accident and may be used to exchange communications with various other sensors present in the vehicle 115. The assistance services computer 105 can evaluate the sensor signal received from the accelerometer and identify the occurrence of the traffic accident. The assistance services computer 105 may then transmit a command to one or more cameras to capture images such as, for example, images of damaged portions of the vehicle 115, images of occupants of the vehicle 115, and/or images of landmarks near the vehicle 115.

The input/output interface 425 may also be used to receive and/or transmit signals to the vehicle computer 110. For example, the input/output interface 425 may be used to receive status information about an operability of the vehicle 115 from the vehicle computer 110 after a traffic accident. When the vehicle 115, is an autonomous vehicle, the assistance services computer 105 may in one situation, communicate via the input/output interface 425 with the vehicle computer 110 to move the vehicle 115 away from a spot of an accident.

The memory 112, which is one example of a non-transitory computer-readable medium, may be used to store an operating system (OS) 450, a database 445, and various code modules such as an assistance services module 435, an image evaluation module 440, and a sensor signal evaluation module 455. The code modules are provided in the form of computer-executable instructions that are executed by the processor 111 to enable the assistance services computer 105 to perform various operations in accordance with the disclosure. The assistance services module 435 can be executed for example, by the processor 111, to perform various operations such as evaluating a sensor signal received from the sensor system 130 (and/or from the vehicle computer 110) and for evaluating various factors associated with a traffic accident.

Execution of some of these operations can include the use of the image evaluation module 440 in order to evaluate various types of images such as, for example, images captured by the camera 120, the camera 150, and/or the camera 145. The sensor signal evaluation module 455 may be used by the assistance services module 435 to evaluate various types of sensor signals such as, for example, a sensor signal received from an accelerometer that is a part of the sensor system 130.

The database 445 may be used to store various types of data such as, for example, images, occupant information, driver information, etc.

It must be understood that in various embodiments, actions performed by the processor 111 of the assistance services computer 105 can be supplemented, complemented, replicated, or replaced by actions performed by other processors in other computers, such as, for example, the processor 161 in the services provider computer 160, a processor in the vehicle computer 110, and a processor in the computer 260. The actions performed by such other computers may be carried out in cooperation with the processor 111 of the assistance services computer 105.

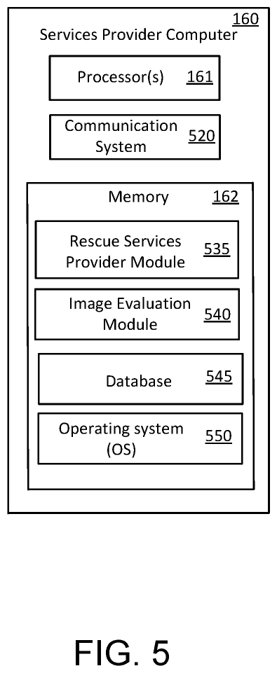

FIG. 5 shows some example components that may be included in the services provider computer 160 in accordance with an embodiment of the disclosure. The services provider computer 160 may include the processor 161, a communication system 520, and the memory 162. The communication system 520 can include one or more wireless transceivers that allow the assistance services computer 105 to communicate with the assistance services computer 105 and the computer 260, for example.

The memory 162, which is another example of a non-transitory computer-readable medium, may be used to store an operating system (OS) 550, a database 545, and various code modules such as an assistance services provider module 535 and an image evaluation module 540. The code modules are provided in the form of computer-executable instructions that are executed by the processor 161 to enable the services provider computer 160 to perform various operations in accordance with the disclosure. The assistance services provider module 535 can be executed for example, by the processor 161, to perform various operations such as, for example, evaluating information provided by the assistance services computer 105 with reference to an event encountered by the vehicle 115, and selecting a suitable assistance vehicle.

Execution of some of these operations can include the use of the image evaluation module 540 in order to evaluate various types of images provided by the assistance services computer 105.

The database 545 may be used to store various types of data such as, for example, information about various vehicles such as the vehicle 205, the tow truck 220, and the UAV 245.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, such as the processor 111, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 112, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method comprising:
detecting, by a first processor, an event that places a first vehicle in a disabled condition;
transmitting, by the first processor, to a second processor, information associated with the event; and
detecting, by the first processor, an arrival of a assistance vehicle that is dispatched by the second processor based on an automated evaluation of the information associated with the event.

2. The method of claim 1, wherein the first vehicle is an autonomous vehicle, wherein the first processor is a part of the autonomous vehicle, and further wherein, the event is at least one of a malfunctioning of a component of the autonomous vehicle or an accident in which the autonomous vehicle is involved.

3. The method of claim 1, wherein the first processor is a part of the first vehicle, and wherein the assistance vehicle is an autonomous vehicle that includes equipment for at least towing the first vehicle.

4. The method of claim 3, wherein the assistance vehicle further includes an item for delivery to an occupant of the first vehicle.

5. The method of claim 4, wherein the item is at least one of a food item, a first aid kit, or a medical device.

6. The method of claim 3, further comprising at least one of an occupant of the first vehicle using the equipment for towing the first vehicle or an individual controlling the assistance vehicle from a remote location to provide a assistance service to the occupant of the first vehicle.

7. A method comprising:
receiving, by a first processor, information associated with an event that places a first vehicle in a disabled condition;
evaluating, by the first processor, the information associated with the event;
identifying, by the first processor, based on evaluating the information, a second vehicle that is equipped to provide a assistance service to the first vehicle; and
dispatching, by the first processor, the second vehicle to provide the assistance service to the first vehicle.

8. The method of claim 7, wherein at least one of the first vehicle or the second vehicle is an autonomous vehicle.

9. The method of claim 7, wherein evaluating the information comprises identifying the event as at least one of a malfunctioning of a component of the first vehicle or an accident in which the first vehicle is involved.

10. The method of claim 9, wherein the second vehicle is an autonomous vehicle, and wherein dispatching, by the first processor, the second vehicle to provide the assistance service to the first vehicle comprises the first processor communicating with a third processor of the autonomous vehicle.

11. The method of claim 9, wherein identifying the second vehicle comprises one of identifying a first equipment provided in the second vehicle and a second equipment provided in a third vehicle, and wherein the method further comprises:
selecting the second vehicle based on determining a suitability of the first equipment to provide the assistance service to the first vehicle.

12. The method of claim 11, wherein the first equipment is a towing equipment and wherein the assistance service provided to the first vehicle is a towing operation.

13. A system comprising:
a first vehicle that includes:
a sensor system;
a first memory including computer-executable instructions; and
a first processor configured to access the first memory and execute the computer-executable instructions to perform operations comprising:
receiving, from the sensor system, a first signal;
detecting, based on evaluating the first signal, a disabled condition of the first vehicle;
identifying, based on evaluating the first signal, an event that triggered the disabled condition of the first vehicle;
automatically transmitting information associated with the event; and
detecting an arrival of a assistance vehicle that is dispatched based on an automated evaluation of the information associated with the event.

14. The system of claim 13, further comprising:
a second memory including computer-executable instructions; and
a second processor configured to access the second memory and execute the computer-executable instructions to perform operations comprising:
receiving the information transmitted by the first processor;
evaluating the information transmitted by the first processor;
identifying, based on evaluating the information, the assistance vehicle that is equipped to provide a assistance service; and
dispatching the assistance vehicle to provide the assistance service.

15. The system of claim 14, wherein at least one of the first vehicle or the assistance vehicle is an autonomous vehicle, and wherein, the event is at least one of a malfunctioning of a component of the first vehicle or an accident in which the first vehicle is involved.

16. The system of claim 15, wherein the second processor is configured to operate autonomously.

17. The system of claim 13, wherein the first processor is further configured to access the first memory and execute the computer-executable instructions to perform additional operations comprising:
automatically transmitting a request for a assistance service along with the information associated with the event;
receiving, from the sensor system, a second signal;
detecting, based on evaluating the second signal, at least one of an operational status of the first vehicle or a physical status of an occupant of the first vehicle; and
automatically transmitting the at least one of the operational status of the first vehicle or the physical status of the occupant of the first vehicle.

18. The system of claim 17, further comprising:
a second memory including computer-executable instructions; and
a second processor configured to access the second memory and execute the computer-executable instructions to perform operations comprising:
receiving the request transmitted by the first processor;
evaluating the information contained in the request;
receiving the at least one of the operational status of the first vehicle or the physical status of the occupant of the first vehicle;
evaluating the at least one of the operational status of the first vehicle or the physical status of the occupant of the first vehicle;
identifying, based on at least one of evaluating the information contained in the request for the assistance service, or evaluating the at least one of the operational status of the first vehicle or the physical status of the occupant of the first vehicle, the assistance vehicle; and
dispatching the assistance vehicle to provide the assistance service.

19. The system of claim 13, further comprising:
a second memory including computer-executable instructions; and
a second processor configured to access the second memory and execute the computer-executable instructions to perform operations comprising:
receiving the information transmitted by the first processor;
receiving, from at least one of a first camera provided in the first vehicle or a second camera provided in an unmanned aerial vehicle, an image that includes at least a portion of the first vehicle;
detecting, based on evaluating the information transmitted by the first processor and/or evaluating the image, an operational status of the first vehicle and/or a physical status of an occupant of the first vehicle;
identifying, based on the operational status of the first vehicle and/or the physical status of the occupant of the first vehicle, the assistance vehicle; and
dispatching the assistance vehicle to provide a assistance service.
